(19) United States
(12) Patent Application Publication
(10) Pub. No.: US 2025/0236540 A1
(43) Pub. Date: Jul. 24, 2025

(54) SYSTEM AND METHOD FOR TREATMENT OF AMMONIA IN A FEED WATER STREAM

(71) Applicant: FLUENCE WATER PRODUCTS AND INNOVATION LTD, Caesarea (IL)

(72) Inventors: Neri NATHAN, Kibbutz Ein Ha-Horesh (IL); Ronen Itzhak SHECHTER, Tel Aviv (IL); Lotan DAGAI, Pardes Hanna (IL)

(73) Assignee: FLUENCE WATER PRODUCTS AND INNOVATION LTD, Caesarea (IL)

(21) Appl. No.: 18/698,625

(22) PCT Filed: Oct. 6, 2022
(86) PCT No.: PCT/IL2022/051071

§ 371 Date: Apr. 4, 2024

Related U.S. Application Data
(60) Provisional application No. 63/253,139, filed on Oct. 7, 2021.

(51) Int. Cl. C02F 1/42; B01D 63/10; B01J 49/06; C02F 3/12; C02F 3/30; C02F 101/16

(52) U.S. Cl. CPC C02F 1/42; B01D 63/10; B01J 49/06; C02F 3/1268; C02F 3/302; C02F 2101/16; C02F 2301/046; C02F 2303/16

(57) ABSTRACT

A system for treatment of ammonia in a feed water stream containing ammonia, the system comprising: an ion exchanger unit comprising: a feed inlet configured to receive the feed water stream; an ion exchanger bed configured to exchange the ammonia in the feed water stream and to provide thereby a treated effluent; and a treated effluent outlet configured to discharge the treated effluent from the ion exchanger unit; and a regeneration unit in fluid communication with the ion exchanger unit and configured to provide a regeneration brine for regenerating the ion exchanger bed, said regeneration unit comprising a Membrane Aerated Biofilm Reactor (MABR) for recovery of the regeneration brine.

### TECHNOLOGICAL FIELD

The present disclosure relates to water treatment.

### BACKGROUND ART

References considered to be relevant as background to the presently disclosed subject matter are listed below:
E. J. McAdam and, S. Judd “Biological treatment of ion-exchange brine regenerant for re-use: A review” Separation and Purification Technology 62 (2008) 264-272
Sukru Aslan and Erdal Simsek “Influence of salinity on partial nitrification in a submerged biofilter” Bioresource Technology 118 (2012) 24-29

Acknowledgement of the above references herein is not to be inferred as meaning that these are in any way relevant to the patentability of the presently disclosed subject matter.

### BACKGROUND

Ammonia and/or nitrogen removal from wastewater is becoming more demanding over time, with requirements to produce effluents with lower ammonia and total nitrogen concentrations. These requirements have led to the development of enhancement technologies, many of which rely on addition of a biofilm process to conventional configurations of the heritage activated sludge process. Some examples for such a biofilm enhancement process include MBBR and aerobic granular sludge (densification).

Another strategy to target low ammonia in some cases and low nitrogen in other cases, is operating at high SRT and high dissolved oxygen concentration, conditions made possible by using MBR technology. However, MBR is a labor and chemicals intensive process, less applicable in many cases.

The above and other conventional processes face challenges or limitations in achieving low effluent ammonia concentrations, and especially controlling the consistent and reliable compliance, including: a) low rates at the lower concentrations, b) means to control and respond to assure compliance and c) sensitivity to fluctuate properties (flow, temperature, strength) of the inlet feed stream.

The low nitrification rates of biofilm processes, associated with low ammonia concentrations (following Monod kinetics) result in large reactor volumes and biofilm surface area requirements, and therefore are economically unattractive. Furthermore, the use of biofilms in combination with suspended biomass, known as IFAS (integrated fixed-film activated sludge) processes renders the suspended biomass lean in nitrifying bacteria.

### GENERAL DESCRIPTION

The present invention relates to systems and methods for ensuring low ammonia concentration in the effluent of wastewater treatment plants using ion exchangers (IX) regenerated by a brine and reclamation of the regeneration brine using membrane aerated biofilm reactors (MABR). The wastewater treatment plant removes only a part of the ammonia thereby resulting in a wastewater effluent with low ammonia concentration, which still requires to be treated for further removal of ammonia. The systems and methods described herein treat the wastewater with low ammonia concentrations at high rates, and in compact systems thereby eliminating the drawbacks of the conventional wastewater treatment systems and methods.

There is thus provided, according to a first aspect of the presently disclosed subject matter, a system for treatment of ammonia in a feed water stream containing ammonia, the system comprising an ion exchanger unit comprising a feed inlet configured to receive the feed water stream; an ion exchanger bed configured to exchange the ammonia in the feed water stream and to provide thereby a treated effluent; and a treated effluent outlet configured to discharge the treated effluent from the ion exchanger unit; and a regeneration unit in fluid communication with the ion exchanger unit and configured to provide a regeneration brine for regenerating the ion exchanger bed, said regeneration unit comprising a Membrane Aerated Biofilm Reactor (MABR) for recovery of the regeneration brine.

According to a second aspect of the presently disclosed subject matter, there is provided a method for removal of ammonia from a feed water stream containing ammonia, the method comprising at least one water treatment stage and at least one system regeneration stage; wherein said water treatment stage comprises feeding the feed water stream into an ion exchanger unit and discharging treated effluent from the ion exchanger unit; and said system regeneration session comprises circulating a regeneration brine through the ion exchanger unit for regenerating the ion exchanger unit and recovering the regeneration brine using a Membrane Aerated Biofilm Reactor (MABR).

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a schematic block diagram of a system and a method for removal of ammonia from a feed water stream containing ammonia according to one embodiment of the presently disclosed subject matter.

FIG. 2 illustrates a schematic block diagram of a system and a method for removal of ammonia from a feed water stream containing ammonia according to another embodiment of the presently disclosed subject matter.

FIG. 3 illustrates a chart showing laboratory test results for three consecutive cycles of ammonia removal from regeneration brine used in system and method of any one of FIGS. 1 and 2.

### DETAILED DESCRIPTION

The presently disclosed subject matter relates to systems and methods for treatment of ammonia in a feed water stream containing ammonia. The feed water stream can be wastewater effluent from a wastewater treatment system, which has at least partially been treated for removal of ammonia therefrom in the wastewater system. The feed water stream may thus have low concentrations of ammonia, which are conventionally difficult to be removed because of the challenges including low removal rates at the lower concentrations, requirements of huge systems, and sensitivity to fluctuate properties of the feed water stream. In some embodiments, the feed water stream is a partially treated wastewater. In some embodiments, the feed water stream is a partially treated wastewater effluent from a wastewater treatment system that comprises a Membrane Aerated Biofilm Reactor (MABR). Other water sources that may be treated by the system(s) and method(s) disclosed herein are lakes, reservoirs, canals, rivers and creeks.

The systems and/or methods of the presently disclosed subject matter eliminates the above-mentioned challenges in treatment of these lower concentration ammonia by using an ion exchanger unit to remove ammonia, regenerating the ion exchanger unit by a regeneration brine, and/or recovering the regeneration brine using a Membrane Aerated Biofilm Reactor (MABR). The method is performed in two stages including a water treatment stage and a system regeneration stage. Based on the volumes of the feed water to be treated, there can be, in some embodiments, more than one of either or each of the stage stages.

In the water treatment stage, the feed water stream is fed into the ion exchanger unit of the system via its feed inlet. The ion exchanger unit has an ion exchanger bed configured to exchange the ammonia in the feed water stream with a cation, and to thereby provide a treated effluent, which is the treated water free of ammonia. The treated effluent is then discharged from the ion exchanger unit.

In the system regeneration stage, a regeneration brine is circulated from a regeneration unit through the ion exchanger unit for regenerating the ion exchanger bed. For instance, during the water treatment stage the ion exchanger bed adsorbs the ammonia from the feed water in exchange of a cation that is released into the feed water. Thus, when the ion exchanger bed gets saturated, or before that, the ion exchanger bed needs to be regenerated with the cation for the operation of water treatment to continue. Therefore, the regeneration brine enriched with a makeup cation, that can be same or different than the cation exchanged by the ion exchanger bed, is fed into the ion exchanger unit. The makeup cation from the regeneration brine is deposited on the ion exchanger bed thereby replenishing the ion exchanger bed with the cation, and the ammonia is loaded into the regeneration brine resulting in a charged brine. The charged brine is discharged from the ion exchanger unit and then recovered again into a fresh regeneration brine in a regeneration unit using the Membrane Aerated Biofilm Reactor (MABR). The system can be configured to feed the makeup cation solution to the charged brine from a makeup cation reservoir, and can include a makeup cation reservoir within the system in communication with the regeneration unit for feeding the makeup cation solution to the charged brine. In some embodiments, the makeup cation solution can comprise at least one cation selected from sodium, potassium, and/or hydrogen. In some embodiments, the makeup cation is sodium, and/or potassium, and/or hydrogen.

In some embodiments, the charged brine is fed with a carbon source including organic compounds suitable for converting nitrate into nitrogen. The regeneration unit provides conditions supporting nitrification and denitrification of the charged brine. The system can be configured to feed the carbon source from an external carbon reservoir, and/or can include a carbon reservoir within the system in communication with the regeneration unit for feeding the carbon source to the charged brine.

The regeneration unit can include a brine holding tank for holding the charged brine and an MABR tank for accommodating the MABR. The MABR can comprise a spirally wound membrane module. In some embodiments, the charged brine can be fed from the ion exchanger unit to the brine holding tank prior to being fed to the MABR tank. In other embodiments, the charged brine can be fed from the ion exchanger unit to the MABR tank prior to being fed to the brine holding tank. Either or both of the makeup cation solution and the carbon source can be fed to any one or both of the brine holding tank and the MABR tank, as appropriate according to their relative order in the process.

The system further comprises a circulation system, constituted by conduits, configured for circulating the regeneration brine from the regeneration unit through the ion exchanger unit and back to the regeneration unit. The system can further comprise at least one pumping mechanism configured to pump the regeneration brine through the circulation system. The system can further comprise a pumping mechanism configured to pump the regeneration brine into the ion exchange unit. The system can further include a filtration mechanism positioned within the circulation system configured to remove suspended solids from the regeneration brine. In some embodiments, the volume of the regeneration brine that is circulated through the ion exchange unit is smaller than the volume of feed water treated by the ion exchange unit. In some embodiments, the volume is at least five times smaller than the volume of feed water stream being treated by the ion exchange unit.

In some embodiments, the system is configured for feeding a makeup cation solution to the regeneration brine unit. In some embodiments, the cation in the brine is selected from the group consisting of sodium, potassium, and/or hydrogen. In some embodiments, the cation in the brine comprises a cation solution. In some embodiments, the cation solution comprises at least one salt and/or base (a hydroxide of the cation, such as sodium hydroxide or potassium hydroxide). In some embodiments, the salt comprises a sodium salt (e.g., NaCl). In some embodiments, the salt comprises a potassium salt (e.g., KCl). In some embodiments, the salt comprises a sodium salt and/or a potassium salt (e.g., KCl). In some embodiments, the salt concentration in the brine is in the range between 1.0% and 3.0%. In some embodiments, the sodium concentration in the brine is in the range between 200 mM and 500 mM (“mM” is referred to herein “millimoles per liter” or “mmoles/liter”). In some embodiments, the sodium concentration in the brine is between 250 mM and 400 mM. In some embodiments, the sodium concentration in the brine is between 300 mM and 350 mM. In some embodiments, the sodium concentration in the brine is in the range between 150 mM and 300 mM

In some embodiments, the potassium concentration in the brine is in the range between 200 mM and 500 mM. In some embodiments, the potassium concentration in the brine is between 250 mM and 400 mM. In some embodiments, the potassium concentration in the brine is between 300 mM and 350 mM. In some embodiments, the potassium concentration in the brine is in the range between 150 mM and 300 mM.

According to a linear fit, it is generally demonstrated that the MABR systems remove ammonia from the brines at a constant rate along the brine recovery cycle, from initial concentrations of more than 250 mg/l to about 50 mg/l. Furthermore, the ammonia removal rate is higher in the lower brine concentration system than in the higher brine concentration. Both rates decrease slightly with each cycle. So, the conclusions are that the working regeneration brine concentration should be optimized between the recovery rate and regeneration efficiency, and that the number of brine recovery cycles might be finite.

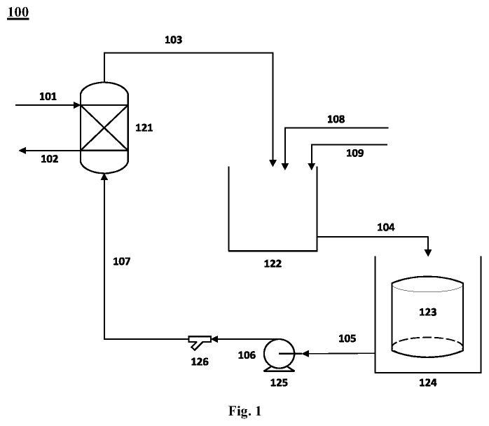

Reference is now made to FIG. 1 illustrating a schematic block diagram of a system 100 and a method for removal of ammonia from a feed water stream 101 containing ammonia according to an embodiment of the presently disclosed subject matter. The system 100 includes an ion exchanger unit 121 for treating the feed water stream 101 and producing a treated effluent 102, a brine holding tank 122 for holding a regeneration brine, an MABR tank 124 with MABR module 123 for recovery of the regeneration brine, a pump 125 for circulation of the regeneration brine through ion exchanger 121, and a filter 126 for removing suspended solids created during biological recovery of the regeneration brine by the MABR module 123.

The feed water stream 101 can be partially treated wastewater, or water mainly contaminated with ammonia. The feed water stream 101 is passed through the ion exchanger unit 121 comprising an ion exchanger bed, packed with an ion exchange material such as a zeolite (for example: chabazite) or a synthetic resin (such as: Amberlite, Purolite or other commercial products).

The ammonia in the feed water stream 101 is exchanged for a cation present in the ion exchanger bed, such as sodium, potassium, or hydrogen, to discharge the treated effluent 102 with a lower concentration of ammonia. Periodically, and preferably upon or prior to saturation of the ion exchanger bed and breakthrough of ammonia to the treated water, the ion exchanger bed is regenerated to replace the ammonia ions removed from feed water stream 101 back with a cation such as sodium or potassium or hydrogen. The regeneration is performed by passing a stream of fresh brine 105 from the MABR tank 124 through the ion exchanger unit 121. The fresh brine 105 from MABR tank 124 is preferably pumped and filtered to obtain a clear brine 107 at sufficient pressure to fill or flow through the ion exchanger unit 121. The clear brine 107 provides the cation solution for replacing the ammonia adsorbed by the ion exchanger bed with a cation from the brine, and a charged brine 103 loaded with ammonia is discharged to the brine holding tank 122 to be ready for the next regeneration cycle.

As illustrated in FIG. 1, a makeup stream 108 is fed into the brine holding tank 122, for replenishment of the cation exchanged with ammonia and discharged in treated effluent 102. The makeup solution fed with the makeup stream 108 may be a base of the cation exchanged with the ammonia, such as sodium hydroxide or potassium hydroxide, or a salt of cation such as chloride or bromide or sulfate or bicarbonate, or any mixture of a base and a salt of the cation. The mixture of the base and the salt are adjusted to achieve replenishment of the loss of the cation exchanged with ammonia through treated effluent 102 as well as control and maintain the pH value of the regeneration brine. In some embodiments, the makeup stream 108 can be fed into the MABR tank. Alternatively, the salt and base may be fed as two separate solutions to any of the holding tank 122 and MABR tank 124 in order to support a specific pH and salinity control scheme. In some embodiments, a strong acid cation exchanger resin is used, in which case the regeneration solution is a strong acid and the cation exchanged with ammonia is a proton. However, the use of a strong acid for regeneration requires pH adjustments.

In the illustrated example according to one embodiment of the present invention, a carbon source through carbon source stream 109 is fed into the holding tank 122, to provide an electron donor for denitrification. In some embodiments, the carbon source stream can be fed into the MABR tank 124. The enriched brine 104 is fed to the MABR tank 124 for further recovery.

The MABR tank 124 comprises at least one oxygen permeable membrane in contact with water on its external surfaces and passing air through the volume in contact with its internal surfaces. The MABR membranes may be structured in any configuration such as spirally wound, hollow fibers or flat sheets. The MABR membranes are preferably packed in the MABR module 123. The MABR module 123 is either connected to a process air inlet and equipped with either a process air vent to the atmosphere or to means for air suction. The MABR tank 124 or MABR module 123 are also equipped with an air diffusers array (not shown) positioned below the MABR module or on the bottom of the tank and configured to provide intermittent mixing of the water in the tank and between the surfaces of the at least one membrane.

The MABR provides aerobic biological oxidation of ammonia by a biofilm that develops on the oxygen permeable membrane. The ammonia is mostly oxidized to nitrate, which may accumulate in the brine over many cycles, but is preferably denitrified using addition of a carbon source which is a readily biodegradable organic material such as any of: methanol or acetate or sugar syrup. Denitrification occurs at anoxic conditions that exist in the water, mostly on the external layers of the biofilm, where oxygen permeating from the membrane has been exhausted and anoxic conditions prevail. The fresh brine 105 thus recovered from the MABR tank 124 is thus ready for another regeneration cycle and is pumped by the pump 125 to achieve a pumped brine stream 106, which is filtered by the filter 126 to achieve the clear brine 107 to be fed to the ion exchanger unit 121 for the next regeneration cycle.

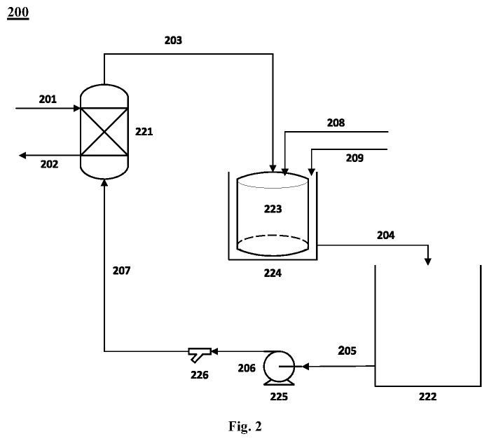

Reference is now made to FIG. 2 illustrating a schematic block diagram of a system 200 and a method for removal of ammonia from a feed water stream 201 containing ammonia according to an embodiment of the presently disclosed subject matter. The system 200 and method performed thereby is similar to the system 100 and its corresponding method, with major differences being that in system 200 the regeneration brine is fed to the MABR tank from the ion exchanger unit prior to being fed to the brine holding tank and the carbon source and makeup cation solution are fed to the MABR tank.

The system 200 includes an ion exchanger unit 221 for treating the feed water stream 201 and producing a treated effluent 202, a brine holding tank 222 for holding a regeneration brine, an MABR tank 224 with MABR module 223 for recovery of the regeneration brine, a pump 225 for circulation of the regeneration brine through ion exchanger 221, and a filter 226 for removing suspended solids created during biological recovery of the regeneration brine by the MABR module 223.

The feed water stream 201 can be partially treated wastewater, or water mainly contaminated with ammonia. The feed water stream 201 is passed through the ion exchanger unit 221 comprising an ion exchanger bed, packed with an ion exchange material such as a zeolite (for example: chabazite) or a synthetic resin (such as: Amberlite, Purolite or other commercial products).

The ammonia in the feed water stream 201 is exchanged for a cation present in the ion exchanger bed, such as sodium, potassium, or hydrogen, to discharge the treated effluent 202 with a lower concentration of ammonia. Periodically, and preferably upon or prior to saturation of the ion exchanger bed and breakthrough of ammonia to the treated water, the ion exchanger bed is regenerated to replace the ammonia ions removed from feed water stream 201 back with a cation such as sodium or potassium or hydrogen. The regeneration is performed by passing a stream of fresh brine 205 through the ion exchanger unit 221. The fresh brine 205 is preferably pumped and filtered to obtain a clear brine 207 at sufficient pressure to fill or flow through the ion exchanger unit 221. The clear brine 207 provides the cation solution for replacing the ammonia adsorbed by the ion exchanger bed with a cation from the brine, and a charged brine 203 loaded with ammonia is discharged to the MABR tank 224 for another cycle of recovery to be ready for the next regeneration cycle.

As illustrated in FIG. 1, a makeup stream 208 is fed into the MABR tank 224, for replenishment of the cation exchanged with ammonia and discharged in the treated effluent 202. In some embodiments, the makeup stream 208 can be fed to the brine holding tank 222. It is to be understood herein that the makeup solution of the makeup stream 208 can be same as that of the makeup stream 108 described above with reference to system 100, and that the makeup stream 208 can function in the same manner as the makeup stream 108 and all the description related to makeup stream 108 applies mutatis mutandis to the makeup stream 208.

In the illustrated example, a carbon source through carbon source stream 109 is fed into the MABR tank 224, to provide an electron donor for denitrification.

The MABR tank 224 and MABR module 223 functions in the same manner as the MABR tank 124 and MABR module 123 described above and the description related to MABR tank 124 and MABR module 123 applies mutatis mutandis to the MABR tank 224 and MABR module 223. The MABR in the system 200 provides nitrogen removal through biological nitrification and denitrification as described for the MABR in the system 100. The recovered brine 204 is fed from the MABR tank 224 to the brine holding tank 222 for holding the brine until it is required for the next regeneration cycle.

The fresh brine 205 is pumped from the brine holding tank 222 by the pump 225 to achieve a pumped brine stream 206, which is filtered by the filter 226 to achieve the clear brine 207 to be fed to the ion exchanger unit 221 for the next regeneration cycle.

In some embodiments, the regeneration brine may be pumped through the ion exchanger unit from bottom to top, or alternatively, in some embodiments, the regeneration brine may be pumped from the bottom to fill the ion exchanger unit, and/or drained after some soaking time to the brine holding tank 122 in the system 100 and/or to the MABR tank 224 in the system 200.

In both the illustrated examples described above, it is a technically advantageous feature of the presently disclosed subject matter that biological recovery of the brine from ammonia is performed in a single step and in a single tank. This is made possible by the stable coexistence of aerobic conditions on the surface of the membrane with anoxic conditions in the body of the water, at which nitrification and denitrification occur simultaneously.

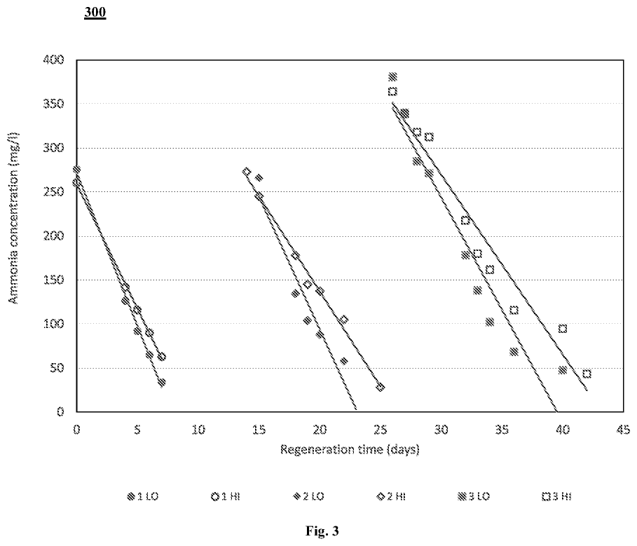

Reference is now made to FIG. 3 illustrating a chart 300 presenting the ammonia concentrations (in terms of mg/l nitrogen) over three consecutive brine recovery cycles in two MABR systems. The three cycles are marked 1, 2, and 3, and the two MABR systems are marked as LO and HI. The HI notation stands for the system operating with a higher NaCl concentration in the brine of 2.5%, whereas the LO notation stands for the system operating with a lower NaCl concentration of 1.25%.

According to the linear fit, it is generally demonstrated that the MABR systems remove ammonia from the brines at a constant rate along the brine recovery cycle, from initial concentrations of more than 250 mg/l to about 50 mg/l. It is emphasized that these concentrations are one embodiment of an operating range which may vary according to operating conditions of the ion exchange system and/or the regeneration system. Furthermore, the ammonia removal rate is higher in the lower brine concentration system than in the higher brine concentration. Both rates decrease slightly with each cycle. Without wishing to be bound by theory, the inventors have found that the working regeneration brine concentration should be optimized between the recovery rate and regeneration efficiency, and that the number of brine recovery cycles might be finite.

1-25. (canceled)

26. A system for treatment of ammonia in a feed water stream containing ammonia, the system comprising:
an ion exchanger unit comprising:
a feed inlet configured to receive the feed water stream;
an ion exchanger bed configured to exchange the ammonia in the feed water stream and to provide thereby a treated effluent; and
a treated effluent outlet configured to discharge the treated effluent from the ion exchanger unit; and
a regeneration unit in fluid communication with the ion exchanger unit and configured to circulate a regeneration brine through the ion exchanger bed, said regeneration unit comprising a Membrane Aerated Biofilm Reactor (MABR) for recovery of the regeneration brine by removal of ammonia.

27. The system of claim 26, comprising a circulation system for circulating the regeneration brine from the regeneration unit through the ion exchanger unit and back to the regeneration unit.

28. The system of claim 26, wherein said feed water stream containing ammonia is a partially treated wastewater.

29. The system of claim 28, wherein said treated wastewater is from a wastewater treatment system comprising at least one MABR.

30. The system of claim 26, comprising a filtration mechanism configured for removing suspended solids from the regeneration brine.

31. The system of claim 26, wherein said MABR comprises one of a spirally wound membrane module, hollow fibers membrane module, or flat sheets membrane module.

32. The system of claim 26, configured for feeding a makeup cation solution to the regeneration brine unit, said makeup cation solution comprises a cation selected from the group consisting of sodium, potassium, and hydrogen.

33. The system of claim 26, configured for feeding a carbon source to the regeneration brine unit, wherein said carbon source comprises organic compounds, suitable for converting nitrate to nitrogen within said MABR.

34. The system of claim 33, in fluid communication with a carbon source reservoir in for feeding said regeneration brine unit with said carbon source.

35. A method for removal of ammonia from a feed water stream containing ammonia, the method comprising at least one water treatment stage and at least one system regeneration stage;
wherein
said water treatment stage comprises feeding the feed water stream into an ion exchanger unit and discharging treated effluent from the ion exchanger unit; and
said system regeneration stage comprises circulating a regeneration brine through the ion exchanger unit for regenerating the ion exchanger unit and recovering the regeneration brine using a Membrane Aerated Biofilm Reactor (MABR).

36. The method of claim 35, wherein a volume of said regeneration brine circulated through said ion exchange unit in a volume that is at least five times smaller than the volume of the feed water stream being treated by the ion exchange unit between brine recovery cycles.

37. The method of claim 35, wherein said recovery of the regeneration brine comprises providing conditions for nitrification and denitrification.

38. The method of claim 35, wherein said MABR comprises at least one MABR module selected from spirally wound membrane module, hollow fibers membrane module, or flat sheets membrane module.

39. The method of claim 35, wherein said MABR comprises at least one spirally wound membrane module in at least one tank.

40. The method of claim 35, comprising adding a makeup cation solution to said regeneration brine, said makeup cation solution comprises at least one cation selected from sodium, potassium, and hydrogen.

41. The method of claim 39, comprising adding carbon source to said regeneration brine, suitable for converting nitrate to nitrogen within said MABR.

42. The method of claim 35, comprising filtering the regeneration brine for removing suspended solids therefrom.

43. The method of claim 35, wherein said feed water stream containing ammonia is a partially treated wastewater.

44. The method of claim 35, wherein said feed water stream containing ammonia is effluent from a wastewater treatment system.

45. The method of claim 44, wherein said wastewater treatment system comprises a MABR.
